(19) United States
(12) Patent Application Publication
(10) Pub. No.: US 2014/0215341 A1
(43) Pub. Date: Jul. 31, 2014

(54) TRANSITIONING BETWEEN PAGES OF CONTENT ON A DISPLAY OF A USER DEVICE

(71) Applicant: LSI CORPORATION, San Jose, CA (US)

(72) Inventors: Roger A. Fratti, Mohnton, PA (US); Rick A. de Pinho, Allentown, PA (US)

(73) Assignee: LSI Corporation, San Jose, CA (US)

(21) Appl. No.: 13/755,684

(22) Filed: Jan. 31, 2013

(51) Int. Cl. G06F 3/0481

(52) U.S. Cl. CPC G06F 3/0481
USPC 715/730

(57) ABSTRACT

A method comprises the steps of determining an amount of time between initiating presentation of a first page in a sequence of pages on a display of a user device and receiving a transition command from a user, the transition command causing the display to transition from presentation of the first page to presentation of a second page in the sequence of pages, determining respective amounts of content in the first and second pages, estimating a rate of content consumption based at least in part on the time and the amount of content in the first page, calculating a content transition time based at least in part on the rate of content consumption and the amount of content in the second page, and transitioning from presentation of the second page to presentation of a third page in the sequence of pages based at least in part on the content transition time.

### FIELD

The field relates generally to user devices, and, more particularly, to displaying content on a user device.

### BACKGROUND

Various user devices provide for the display of electronic books, commonly referred to as ebooks. For example, there are a number of user devices dedicated solely to ebook reading, referred to herein as ebook readers. In addition, many other user devices such as cellular phones, tablets, laptops, desktops, etc. provide software and/or other functionality for viewing ebooks. In current ebook readers and other user devices, the content viewable on the screen of a display is transitioned from one page to the next in response to an explicit page turn command from the user. The page turn command may be via a dedicated button on a keyboard, mouse or other input device, a touch gesture on a touchscreen device, etc. Currently, ebook readers and other user devices fail to provide adequate capability for automatic page turning.

### SUMMARY

In one embodiment, a method comprises the steps of determining an amount of time between initiating presentation of a first page in a sequence of pages on a display of a user device and receiving a transition command from a user, the transition command causing the display to transition from presentation of the first page to presentation of a second page in the sequence of pages, determining respective amounts of content in the first page and the second page, estimating a rate of content consumption based at least in part on the time and the amount of content in the first page, calculating a content transition time based at least in part on the rate of content consumption and the amount of content in the second page, and transitioning from presentation of the second page on the display to presentation of a third page in the sequence of pages on the display based at least in part on the content transition time. The determining an amount of time, determining respective amounts of content, estimating, calculating and transitioning steps are performed by at least one processing device.

Other embodiments of the invention include, by way of example and without limitation, user derives, integrated circuits and computer-readable storage media having computer program code embodied therein.

### BRIEF DESCRIPTION OF THE DRAWINGS

FIG. 1 shows a user device, according to an embodiment of the invention.

FIG. 2 shows a display of the user device of FIG. 1, according to an embodiment of the invention.

FIG. 3 shows an example of transition indicators on the display of the user device of FIG. 1, according to an embodiment of the invention.

FIG. 4 shows a methodology for content transitioning, according to an embodiment of the invention.

FIG. 5 shows a timing diagram for content transitioning, according to an embodiment of the invention.

FIG. 6 shows another methodology for content transitioning, according to an embodiment of the invention.

### DETAILED DESCRIPTION

Embodiments of the invention will be illustrated herein in conjunction with exemplary user devices, methods, etc. It is to be understood, however, that techniques of the present invention are not limited to the user devices and methods shown and described herein. For example, while various embodiments of the invention may be described with respect to a user device which is an ebook reader, the invention is not limited solely for use to ebook readers. Instead, the invention is more generally applicable to a wide variety of user devices, including but not limited to items such as cellular phones, tablets, laptops, personal digital assistants, handheld gaming devices, mobile user devices, mobile communication devices, etc. Likewise, embodiments of the invention may be used in conjunction with user devices of a variety of form factors, including but not limited to those commonly referred to within the field as tablets, clamshells, sliders, etc. Further, although embodiments of the invention depict a user device with a touch screen input display, embodiments of the invention may use any input device or combination of input devices, such as trackballs, styluses, touchpads, microphones, keyboards, etc. Likewise, the display of the user device may be any one of or combination of display types such as liquid crystal display (LCD), light emitting diode (LED) display, plasma display, electronic paper, etc. Additional embodiments may be implemented using components other than those specifically shown and described in conjunction with the illustrative embodiments.

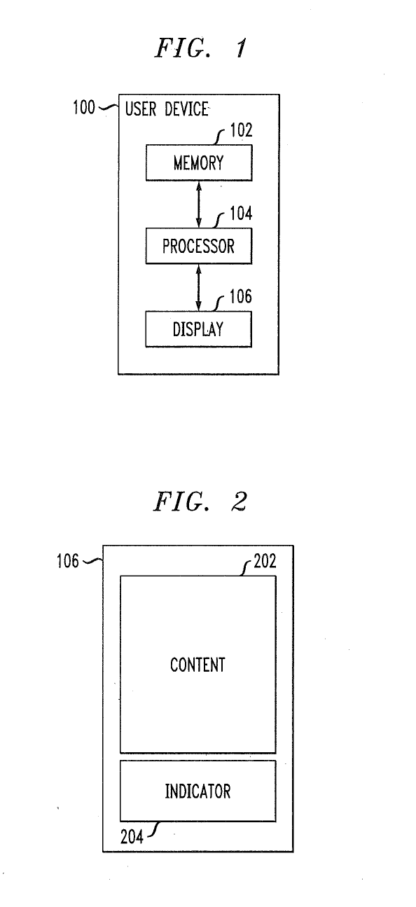

FIG. 1 illustrates a user device 100. The user device 100 has a memory 102 operatively connected to a processor 104. The processor 104 is operatively connected to a display 106. The processor 104 may comprise, for example, a microprocessor, an application-specific integrated circuit (ASIC), a field-programmable gate array (FPGA), a central processing unit (CPU), or other similar processing device components, as well as combinations of such components. The memory 102 may comprise, for example, random access memory (RAM), read-only memory (ROM), magnetic memory, optical memory, hard disk drive (HDD) memory, flash memory, or other types of storage devices in any combination. As discussed above, the display 106 may comprise an LCD display, an LED display, a plasma display, an electronic paper display, or other display types in any combination. While not explicitly shown in FIG. 1, the user device 100 may also have a network interface component for communicating over a network such as a wide area network (WAN) such as the Internet, a local area network (LAN), a cellular network, a Bluetooth® network, or any other type of network, as well as combinations of multiple networks.

In many current user devices, which include dedicated ebook readers and other user devices, there is no automatic page turn capability or the existing automatic page turn capability is inadequate. Currently, there is a trend toward user devices whose sole input is via a touch screen. Thus, every time a user wishes to change a page for an ebook, a touch screen input is required. The touch input may be a swipe gesture, a touch on a specific area or portion of the touch screen, etc. As a result, the display or screen of the user device after some time may become filled with smudges or marks which reduce readability and/or the aesthetic appeal of the device.

Repetitive inputs, whether via touch, button press or other input types, which are required during a reading session, may be uncomfortable for the user and lead to finger fatigue. In various reading situations, making the required swipe motion is uncomfortable or difficult for the user. By way of example only, a user who wishes to read an ebook while running on a treadmill or otherwise exercising may have trouble ensuring that the touch input is directed to a specific area of the touch screen, or may find it difficult to perform the required swipe gesture without interrupting the exercise. As another example, some user devices can be heavy or be shaped such that comfortably holding such devices requires the use of both hands. In such cases, constantly requiring the user to remove one hand from supporting the device to inputting the page turn command may be uncomfortable or difficult.

In addition, automatic page turn capability can make user devices more accessible for disabled users, such as those who suffer from arthritis, carpal tunnel syndrome, reduced dexterity in the hands, and various other conditions which make performing the required repetitive page turn input difficult.

Current automatic page turn capability is typically limited solely to a timer-based approach. A user may enable automatic page turn capability, and the user device will initiate a page turn every x seconds. While a user may be able to adjust the timer speed x in an attempt to account for reading speed, a need exists for more fine-tuned page turn capability. For example, existing approaches do not account for differences in the amount of content on successive pages of the ebook. By way of example, in many books the title page, the first page in a chapter, the last page in a chapter, etc. may have significantly less content than other pages in the ebook. Similarly, pages in an ebook which contain images such as pictures, equations, borders, symbolic page breaks within a chapter, etc. can disrupt the normal page turn speed. Timer-based approaches, however, do not account for the amount of content in pages in determining when to initiate a page turn.

Another drawback of current automatic page turn features is the inability to delay or pause an automatic page turn without simply turning off or disabling the automatic page turn feature. For example, a given page of the ebook may comprise a number of images, equations, maps, etc. which the user may take more time to read than text and as such the simple timer-based approach will initiate a page turn before the user is finished reading the page. Alternatively, the user may become distracted while reading a given page, and the ability to delay the automatic page transition is desirable. For example, in ebook readers which use an electronic paper display, changing the page too fast may be particularly inconvenient for the user. Electronic paper displays typically take longer than other display types to refresh a page, or may cache a number of pages for fast page turn before doing a full page refresh. If the automatic page turn initiates a page turn which will require a full refresh, an unacceptable delay to the user may occur.

In addition, a user is typically unaware that a page turn is imminent, as no indication is provided of an upcoming automatic page turn. Pages that contain graphs, plots or equations may also require further examination by the user or reader causing the need for more time on a page. The imminent page turn indication feature allows the user to read and study all types of material on the page without the anxiety of the page turning too quickly. The imminent page turn indication allows the user to extend the time allotted to the current page while keeping the automatic page turn feature active.

FIG. 2 shows an example of the output on a screen of display 106 of user device 100. A portion of the display 106 presents content 202, and a portion of the display 106 presents an indicator 204. The indicator 204 may comprise a numerical countdown in seconds to the next page turn, a progress bar, a clock icon with turning hands, an hourglass, or various other timing indicators and combinations of timing indicators. In addition, while FIG. 2 shows the indicator 204 at the bottom right portion of the display 106 below the content 202, one skilled in the art will readily appreciated that various other arrangements are possible. For example, the indicator 204 may be above the content 202 on the display 106 or aligned to the center or left of the display 106 rather than the right. In addition, the indicator may not be displayed on a separate portion of the display 106 than the content 202, but may instead by overlayed on the content 202.

It is important to note that the term “output” as used herein is intended to be construed broadly. For example, in some display technologies such as LCD displays, the content on the screen of the display is continually output or refreshed periodically. In other display technologies such as electronic paper, the content of the screen is output once, and not refreshed or changed until some action by the user. Accordingly, output is to be construed broadly to cover a wide variety of display technologies. In addition, the term “presentation” as used herein is intended to be construed broadly as the image, text and other content, etc. which is viewable by a user on the screen of a display. Thus, changing the presentation of a display refers to changing the image, text and other content which is viewable on the screen of the display.

In some embodiments, the user device 100 may comprise more than one display. In these embodiments, the content 202 may be presented on a first display while the indicator 204 is presented on a second display. The indicator 204 may also be represented via an LED separate from the display 106. The LED may blink to indicate an imminent page turn, or change colors to indicate the time remaining until the next page turn. For example, the LED may change from green to yellow to red as the time for a next page turn approaches. The LED may also change in brightness or intensity as the time for a next page turn approaches. Examples of aesthetically pleasing indicators include an hour glass, or circular pie chart that fills in as the time to expiration is reached. These symbols are readily enabled on electronic paper displays and use less power than conventional LED indicator lights.

In still other embodiments, the indicator 204 may not be a visual indicator but may instead by an audio indicator. The indicator 204 may be a chime or other audio output indicative of an imminent page turn. Alternatively or additionally, the indicator 204 may cause the device to vibrate in varying levels of intensity as the time for a next page turn approaches. One skilled in the art will readily appreciate that various other types of indicators may be used, including any combination of the indicators described above.

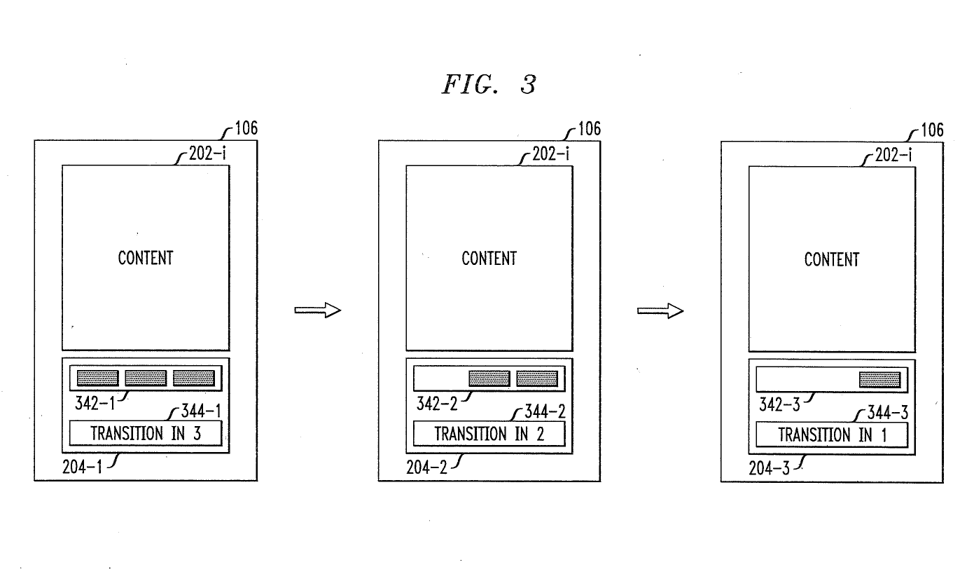

FIG. 3 illustrates an example of transition indicators 204 on the display 106 of user device 100 when an automatic page turn is imminent. The display 106 in FIG. 3 is currently presenting content 202-i, which may be a page of an ebook. In FIG. 3, the indicator 204 is displayed 3 seconds prior to the automatic page turn. It is important to note, however, that the indicator may be displayed at any predetermined time prior to the automatic page turn. In some embodiments, the indicator 204 may be displayed continuously, with a running countdown to the next page turn. In other embodiments, the indicator 204 is displayed for some other predetermined time prior to the automatic page turn, such as 3 seconds as in FIG. 3. The user device 100 may allow the user to specify when and how the indicator 204 is displayed when enabling an automatic page turn feature.

As shown in FIG. 3, the indicator 204-1 initially shows three bars 342-1 and the text “Transition in 3” 344-1. While the content 202-i presented on display 106 remains the same, the indicator 204-1 is updated to indicator 204-2, showing two bars 342-2 and the text “Transition in 2” 344-2. Again, while the content 202-i presented on display 106 remains unchanged, the indicator 204-2 is updated to indicator 204-3, showing a single bar 342-3 and the text “Transition in 1” 344-3. It is important to note that while FIG. 3 illustrates an example wherein the indicator 204 shows a progress bar and the numerical time remaining until the next automatic page turn, in other embodiments only a single one of the progress bar and the numerical time may be used, as well as any other one of or combination of the various indicators described above.

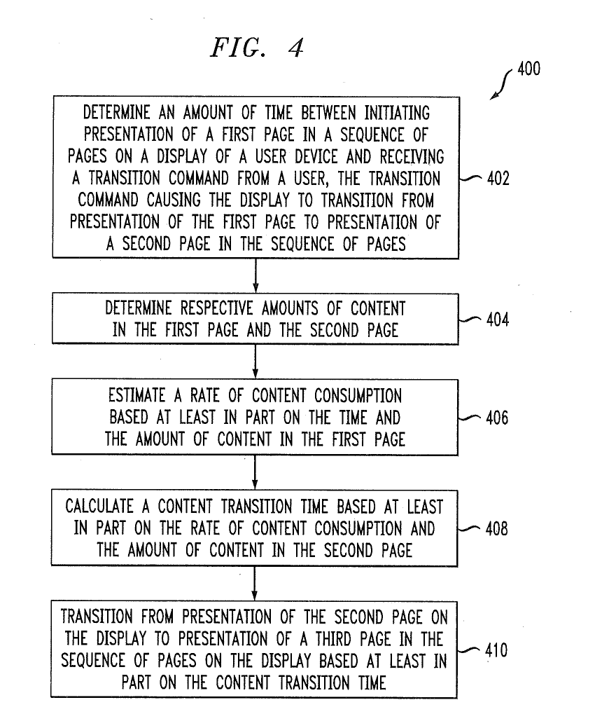

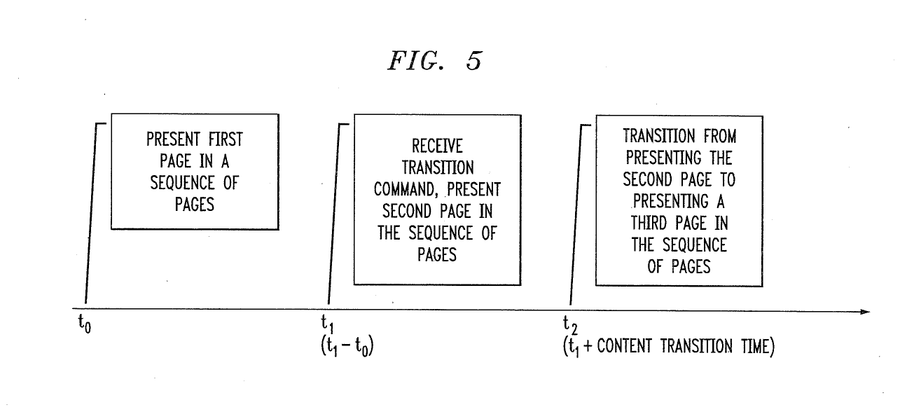

FIG. 4 illustrates a methodology 400 for content transitioning. The methodology 400 begins with step 402, where an amount of time between initiating presentation of a first page in a sequence of pages on a display of a user device and receiving a transition command from a user is determined. The transition command causes the display to transition from presentation of the first page to presentation of a second page in the sequence of pages. As described above, the sequence of pages may comprise an ebook. It is important to note, however, that embodiments of the invention are not limited solely to use with ebooks, but may instead be used for a variety of content types including but not limited to, articles, web page content, slideshows, etc. Step 402 of methodology 400 is performed after the user has enabled an automatic page turn or content transitioning feature.

Accordingly, the term “page” as used herein is intended to be construed broadly. For example, a page of an ebook does not necessarily correspond to a specific page in a physical book. Instead, the term page merely refers to a portion of the content of the ebook that is presented on the display of the user device. Pages may also change dynamically. Many ebook readers allow the user to change the size of the text, and thus the content of a page may vary as selected by the user. Similarly, a page does not necessarily refer to an entire web page or slide of a slideshow, but may instead refer to a portion of the content of a web page or slide of a slideshow that is presented on the display of the user device at a particular point in time.

The term “first page” as used in this context does not necessarily refer to the first page of an ebook or other content. Instead, the term first page is intended to be broadly construed so as to encompass, for example, the first page which is presented on the display after a user has enabled the automatic page turn or content transitioning feature of the user device. In addition, the first page may refer to a page which is already presented or output on the display at the time the user enables the automatic page turn or content transitioning feature.

The term “sequence of pages” is intended to be construed broadly. For example, the sequence of pages may be an ebook, a multi-page article, web page content, a slideshow, etc. as described above. The sequence of pages, however, does not require that there be a relationship between the content of the first page and the content of the second page. For example, the sequence of pages may be a sequence of web pages, such as a sequence of web pages returned in response to a web search. The sequence of web pages may be displayed in turn on the user device, although there is no relationship between the content of the first web page and the content of the second web page in the sequence of web pages. As another example, the sequence of pages may comprise a sequence of multi-page articles such as a newspaper. Embodiments of the invention may use various other sequences of pages in addition to those described above.

The term “initiating” as used herein refers to the initial presentation of the first page on the display of the user device. It is important to note, however, that this need not necessarily be the first time that the user has viewed the first page. For example, the user may have previously read the ebook, and thus the user has viewed the first page before. The time may be measured from when the user has enabled the automatic page turn or content transitioning feature, or the time may measure the elapsed time since a transition command was received to transition the display from presentation of a previous page and presentation of the first page.

The methodology 400 continues with step 404, where the respective amounts of content in the first page and the second page are determined. Embodiments of the invention may use a variety of techniques for determining the amounts of content in the first page and the second page. For example, one technique is a word count of text on the first and second pages. Another technique is a character count of the text on the first and second pages. In some instances, a user may prefer a character count over a word count, as the character count may more accurately reflect the time it takes for the user to read the pages. Yet another technique involves an image count, or determining a portion of the display of the user device which contains non-textual items.

In some embodiments, combinations of the above techniques may be used for determining the respective amounts of content on the first and second pages. For example, in some embodiments determining the amount of content in the first and second pages comprises a word count and an image count. Using the image count in conjunction with the word count advantageously differentiates between pages with images and pages with blank spaces. A user will typically spend some time reading or viewing the image, while spending no time reading blank space. Similarly, the character and image count or the character, word and image count techniques may be combined in embodiments of the invention. In other embodiments, a user device may be configured to allow the user to select one or more of the above described techniques for determining the amount of content when enabling the automatic page turn or content transitioning feature.

After determining the respective amounts of content in the first and second pages in step 404, the methodology 400 continues with step 406 where the rate of content consumption is estimated based at least in part on the time and the amount of content in the first page. The time represents the elapsed time between the presentation of the first page on the display and the time at which the transition command is received from the user determined in step 402. The amount of content in the first page is determined in step 404. In some embodiments, estimating the rate of content consumption (i.e., the reading speed of the user) is a number of words per unit time, characters per unit time, images per unit time, words plus images per unit time, etc.

In step 408, a content transition time is calculated based at least in part on the rate of content consumption estimated in step 406 and the amount of content in the second page determined in step 404. In some embodiments, the content transition time may be further based on one or more previously determined rates of content consumption. The user device may be configured to compile and store statistics regarding page turn speed before the automatic page turn feature is enabled, or during previous reading sessions in which the automatic page turn feature was enabled. Such statistics may be used to more accurately calculate the content transition time. In addition, in some embodiments the user device may have a number of user profiles such that statistics for multiple different readers are stored. When enabling the automatic page turn or content transitioning mode, the user may then select a given user profile and corresponding content consumption statistics to use for calculating the content transition times. Next, in step 410 the display is transitioned from presentation of the second page to presentation of a third page in the sequence of pages based at least in part on the content transition time.

FIG. 5 illustrates a timing diagram for content transitioning in accordance with the methodology 400. At time t₀, a first page in the sequence of pages is presented on the display of a user device. At time t₁, a transition command is received from a user, and the second page in the sequence of pages is presented on the display of the user device. Thus, time t₁ represents time t₀ plus the elapsed time between initiating presentation of the first page and receiving the transition command. It is important to note that although FIG. 5 shows the transition command and the presentation of the second page occurring simultaneously at time t₁ for clarity, there may be some delay between the transition command and presentation of the second page. For example, the user device may take some time to process the transition command and transition from presentation of the first page to presentation of the second page. Such delays may be taken into account when determining the rate of content consumption.

The respective amounts of content for the first page and the second page are determined, and the rate of content consumption is estimated in order to calculate the content transition time as described above. Then, at a time t₂ equal to time t₁ plus the content transition time, the presentation of the display is transitioned from the second page to a third page in the sequence of pages. To illustrate a concrete example, let t₀=0 seconds, t₁=20 seconds, the amount of content in the first page P1_{content}=100 words, and the amount of content in the second page P2_{content} 90 words. Thus, the rate of content consumption (r_{cc}) is equal to 5 words per second (P1_{content}/(t₁−t₀)). The content transition time would then be 18 seconds (P2_{content}/r_{cc}).

Various embodiments have been described above which begin automatic page turning or content transitioning immediately after a first page is read and a transition command is received, it is important to note that the invention is not limited solely to this arrangement. Instead, in some embodiments steps 402-406 may be performed a number of times (i.e., for five or ten manual transitions between one page and the next) to get a more accurate estimate of the rate of content consumption prior to performing steps 408 and 410. Alternatively or additionally, the rate of content consumption may be adjusted based on feedback from the user as will be described below.

While not explicitly shown in the timing diagram of FIG. 5, embodiments of the invention are not limited solely to performing a single automatic page turn between the second page and the third page in the sequence of pages. Instead, embodiments may further perform an automatic page turn between the third page and a fourth page in the sequence of pages, and between the fourth page and a fifth page in the sequence of pages, etc. Embodiments will determine the amounts of content in the fourth page, the fifth page, etc. to determine updated content transition times for transitioning between the third page and the fourth page and the fourth page and the fifth page, etc.

There may be instances where a user finishes reading a given page in the sequence of pages prior to the content transition time. In such instances, the user may input the transition command to change pages without waiting until the automatic page turn at the content transition time. Embodiments of the invention may use such a transition command to adjust the rate of content consumption of the user and to update subsequent content transition times. In other instances, the user may see a transition indicator such as the indicator 204 described above and determine that more time is needed to read the content on a given page. Thus, the user may input a delay command which delays the content transition time. Embodiments of the invention may use such a delay command to adjust the rate of content consumption of the user and to update subsequent content transition times.

In some embodiments, the content transition time may be “paused” temporarily upon activation of one or more features of the user device. For example, many ebook readers and other user devices provide a feature for performing a dictionary lookup of a word on a page. As such, embodiments of the invention may pause a countdown of the time remaining until the content transition time when a user performs a dictionary lookup and resume the countdown when a user exits the dictionary lookup. This pause feature may be used with a variety of other features for a given user device.

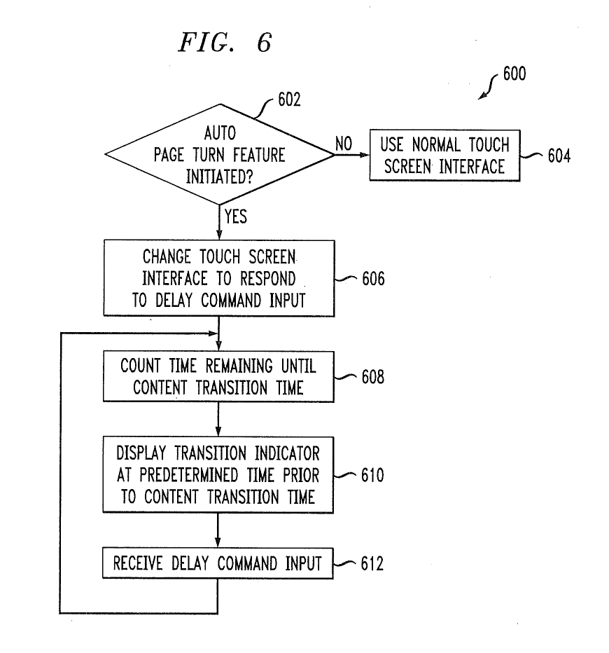

FIG. 6 illustrates a methodology 600 for content transitioning for a touch-screen user device. In step 602, a determination is made as to whether an automatic page turn feature is initiated. If the automatic page turn feature is not initiated, the normal touch screen interface is used 604. If the automatic page turn feature is initiated, the touch screen interface is changed 606 to respond to a delay command input. In some embodiments, the delay command input may be a touch input or gesture on any portion of the display of the user device. In other embodiments, the delay command input may be a touch input or gesture on specific portion or portions of the display of the user device. The time remaining until the content transition time is counted in step 608. The content transition time may be calculated as described above with respect to methodology 400. Next, in step 610 a transition indicator such as indicator 204 described above is presented on the display at a predetermined time prior to the content transition time. Upon receiving 612 the delay command input, the methodology 600 returns to step 608, where the time remaining until the content transition time is counted. The delay command may cause the count to increase for a predefined time such as 5 or 10 seconds. It is important to note that although the methodology 600 of FIG. 6 is described with respect to a touch screen user device, one of ordinary skill in the art will readily appreciate that the methodology 600 may be adapted for use with user devices with a variety of input types.

Embodiments of the invention may be implemented in the form of integrated circuits. In fabricating such integrated circuits, identical die are typically formed in a repeated pattern on a surface of a semiconductor wafer. Each die includes a memory device with a memory array, sense amplifiers and control circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of this invention.

It should again be emphasized that the above-described embodiments of the invention are intended to be illustrative only. For example, other embodiments can use different types and arrangements of displays, input devices, etc. for implementing the described page turn functionality. Also, the particular manner in which certain steps are performed in the signal processing may vary. Further, although embodiments of the invention have been described with respect to ebook readers, embodiments of the invention may be implemented various other user devices such as described above. These and numerous other alternative embodiments within the scope of the following claims will be apparent to those skilled in the art.

What is claimed is:

1. A method comprising the steps of:
determining an amount of time between initiating presentation of a first page in a sequence of pages on a display of a user device and receiving a transition command from a user, the transition command causing the display to transition from presentation of the first page to presentation of a second page in the sequence of pages;
determining respective amounts of content in the first page and the second page;
estimating a rate of content consumption based at least in part on the time and the amount of content in the first page;
calculating a content transition time based at least in part on the rate of content consumption and the amount of content in the second page; and
transitioning from presentation of the second page on the display to presentation of a third page in the sequence of pages on the display based at least in part on the content transition time;
wherein the determining an amount of time, determining respective amounts of content, estimating, calculating and transitioning steps are performed by at least one processing device.

2. The method of claim 1, wherein the user device comprises an ebook reader.

3. The method of claim 1, wherein the sequence of pages comprises consecutive pages of an ebook.

4. The method of claim 1, wherein the respective amounts of content comprise character counts.

5. The method of claim 4, wherein the rate of content consumption comprises a number of characters per unit time.

6. The method of claim 1, wherein the respective amounts of content comprise word counts.

7. The method of claim 6, wherein the rate of content consumption comprises a number of words per unit time.

8. The method of claim 1, wherein the respective amounts of content comprise counts of non-text items, and at least one of character counts and word counts.

9. The method of claim 1, wherein the transitioning step further comprises:
presenting a transition indicator on the display of the user device; and
delaying transitioning from presentation of the second page to presentation of the third page responsive to receiving a delay command from the user.

10. The method of claim 9, wherein the transition indicator is presented on the display of the user device at a predetermined time prior to the content transition time, the transition indicator indicating a time remaining until the content transition time.

11. The method of claim 9, further comprising the step of adjusting the rate of content consumption responsive to receiving the delay command.

12. The method of claim 9, wherein the transition indicator comprises at least one of:
a time in seconds remaining until the content transition time; and
a progress bar indicative of a time remaining until the content transition time.

13. The method of claim 1, wherein the transitioning step further comprises transitioning from presentation of the second page to presentation of the third page prior to the content transition time responsive to receiving another transition command from the user.

14. The method of claim 13, further comprising the step of adjusting the rate of content consumption responsive to receiving the other transition command.

15. The method of claim 1, wherein the transitioning step further comprises delaying transitioning of presentation of the second page to presentation of the third page without adjusting the rate of content consumption responsive to activation of a given feature of the user device.

16. The method of claim 15, wherein the given feature comprises a dictionary look-up of a word on the second page.

17. A processor-readable storage medium comprising executable program code for implementing the method of claim 1.

18. A user device, comprising:
a display;
a memory; and
a processor coupled to the memory, the processor being configured to:
determine an amount of time between initiating presentation of a first page in a sequence of pages on the display and receiving a transition command from a user, the transition command causing the display to transition from presentation of the first page to presentation of a second page in the sequence of pages;
determine respective amounts of content in the first page and the second page;
estimate a rate of content consumption based at least in part on the time and the amount of content in the first page;
calculate a content transition time based at least in part on the rate of content consumption and the amount of content in the second page; and
transition from presentation of the second page on the display to presentation of a third page in the sequence of pages on the display based at least in part on the content transition time.

19. The user device of claim 18, wherein the display comprises a touch-screen display.

20. An integrated circuit, comprising a processor configured to:
determine an amount of time between initiating presentation of a first page in a sequence of pages on a display of a user device and receiving a transition command from a user, the transition command causing the display to transition from presentation of the first page to presentation of a second page in the sequence of pages;
determine respective amounts of content in the first page and the second page;
estimate a rate of content consumption based at least in part on the time and the amount of content in the first page;
calculate a content transition time based at least in part on the rate of content consumption and the amount of content in the second page; and
transition from presentation of the second page on the display to presentation of a third page in the sequence of pages on the display based at least in part on the content transition time.
